(19) United States
(12) Patent Application Publication
(10) Pub. No.: US 2004/0067017 A1
(43) Pub. Date: Apr. 8, 2004

(54) Technique and method for manufacturing distributed feedback structures in Ti:LiNbO3 waveguides

(76) Inventors: Stanislav I. Ionov, Calabasas, CA (US); Oleg M. Efimov, Newbury Park, CA (US); Robert R. Hayes, Calabasas, CA (US); Stewart O. Fong, Torrance, CA (US)

Correspondence Address: ARTZ & ARTZ, P.C., 28333 TELEGRAPH RD., SUITE 250, SOUTHFIELD, MI, 48034, US

(21) Appl. No.: 10/266,836

(22) Filed: Oct. 8, 2002

(51) Int. Cl. G02B 6/34

(52) U.S. Cl. 385/37

(57) ABSTRACT

A method for manufacturing a distributed feedback reflector comprises forming a waveguide (32) on a wafer, applying a photoresistive material to the wafer, forming a grating on the photoresistive material, developing the photoresistive material, and milling the substrate to form the distributed feedback reflector.

### TECHNICAL FIELD

The present invention relates generally to communication systems, and more particularly, to distributed feedback reflectors used in electro-optically active waveguides.

### BACKGROUND ART

Many satellite and terrestrial optical communication systems require transmission of analog optical signals. Commonly, amplitude modulation of the optical carrier is used. However, this approach suffers from poor signal to noise ratio. It is well known that broadband modulation schemes that utilize higher bandwidth than that of the transmitted waveform may improve the signal to noise ratio over that using amplitude modulation. Pulse position modulation (PPM) is one such technique. In pulse position modulation, a shift in the pulse position represents a sample of the transmitted waveform. This is shown in FIG. 1. It can be shown that for a given power source SNR_{PPM}αSNR_{AM}(tₚ/τ)² where t_{P} is the spacing between the unmodulated pulses and τ is the pulse duration, respectively. Pulse position modulation for optical communications requires new techniques for generating trains of optical pulses whose positions are shifted from their unmodulated positions in proportion to the amplitude of a transmitted waveform. Various types of devices are known to those skilled in the art. Such devices utilize distributed feedback reflectors in electro-optically active waveguides. Techniques for forming distributed feedback methods are inconsistent.

It would therefore be desirable to provide a method for forming distributed feedback reflectors.

### SUMMARY OF THE INVENTION

The present invention provides a method for forming distributed feedback reflectors using titanium-doped lithium niobate (Ti:LiNbO₃).

In one aspect of the invention, a method for manufacturing a distributed feedback reflector comprises forming a waveguide on a wafer, applying a photoresistive material to the wafer, forming a grating on the photoresistive material, developing the photoresistive material, and milling the substrate to form the distributed feedback reflector.

In a further aspect of the invention, a method of forming an optical communication system comprises forming a waveguide on a lithium niobate wafer, applying an adhesion promoter to the wafer, applying a photoresistive material to the wafer, exposing the wafer to ultraviolet, forming a grating on the photoresistive material, developing the photoresistive material, milling the substrate to form the distributed feedback reflector, and coupling the distributed feedback reflector into the optical communication network.

One advantage of the invention is that a method for accurately forming a distributed feedback reflector is formed.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a plot illustrating a pulse position modulation technique according to the prior art.

FIG. 2 is a high level view of a communication system having a reflector formed according to the present invention.

FIG. 3 is an opto-electric delay generator having a reflector formed according to the present invention.

FIG. 4 is a flow chart illustrating the process for making the reflector according to the present invention.

FIG. 5 is a diagrammatic view of an interferometer used to form the present invention.

FIG. 6 is a diagrammatic view of an analyzer device used to form the reflector of the present invention.

FIG. 7 is a plot of wavelength versus reflection for the device illustrated in FIG. 6 having a uniform grading.

FIG. 8 is a plot of reflection versus wavelength for a chirped grating using the device of FIG. 6.

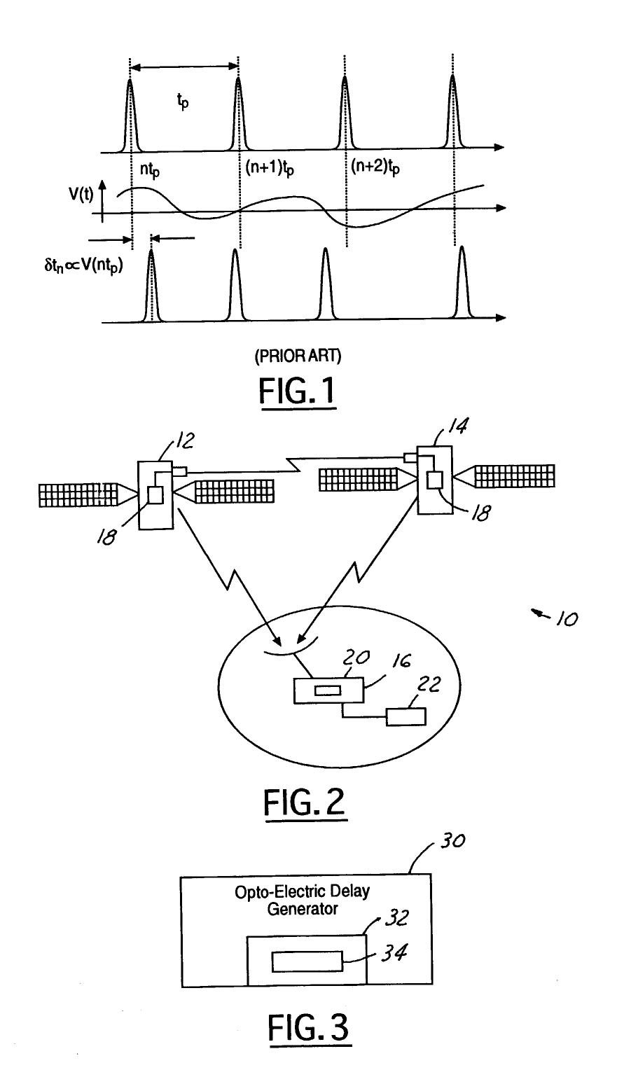

### BEST MODES FOR CARRYING OUT THE INVENTION

In the following figures the same reference numerals will be used to identify the same components in the various views.

While the present invention is described with a specific method for manufacturing, various alternative embodiments, additional steps and various different types of materials and parameters would be evident to those skilled in the art.

Referring now to FIG. 2, a communication system 10 is illustrated using optical communications. Optical communication system is illustrated with respect to a first satellite 12 and a second satellite 14 and a gateway station 16 positioned on the earth. The present invention, of course, is not limited to space-based communication systems. The present invention is applicable to various types of terrestrial and extraterrestrial optical communication systems. Satellite 12 includes an optical communication system 18. Satellite 14 also includes an optical communication system 18. Gateway station 16 may also include an optical communication system 20. Consequently, satellites 12 and 14 may communicate using optical signals. Also, gateway station 16 may also communicate directly with satellites 12 and 14 using optical communications. In a commercial embodiment communication between satellites 12 and 14 is most likely. Gateway station 16 and thus optical communication system 20 may communicate with other data sources 22 using optical communication. As can be seen, the present invention employs the optical communication systems 18, 20 that may be used in a variety of manners.

Referring now to FIG. 3, a portion of optical communication system 18 is illustrated. It should be noted that optical communication system 20 may also be configured in a similar manner. Optical communication system 18 includes an opto-electric delay generator 30 that includes an electro-optic waveguide 32 that includes a distributed feedback reflector 34. Various types of electro-optical delay generators are known. Two such examples are described in U.S. patent application Ser. No. 09/545,632 filed Apr. 7, 2000, and U.S. patent application Ser. No. 09/896,953 filed Jun. 29, 2001, the disclosures of which are incorporated by reference herein. The focus of the present invention is the manufacture of the distributed feedback reflector 34.

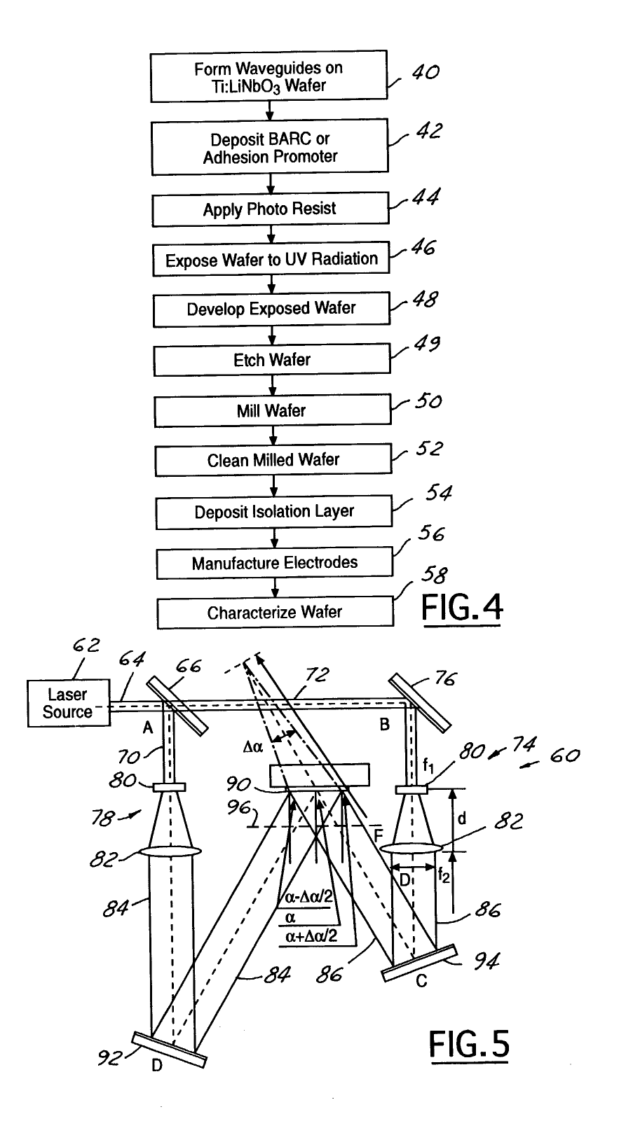

Referring now to FIG. 4, a method for forming the distributed feedback reflector 34 is illustrated. In the present invention, a lithium niobate (LiNbO₃) substrate or wafer is used. In the present embodiment, a three inch Z-cut lithium lithium niobate wafer, which has been doped with titanium to form five to eight micron-wide waveguides, is used. Of course, other wafer cuts such as a y-cut may be chosen for different applications. Once the titanium-doped waveguides are formed on a wafer in step 40, the wafer is then waveguide side coated in step 41 with a broadband anti-reflection coating (BARC) or an adhesion promoter to the side that has the waveguides. BARC helps in removing interference fringes caused by UV reflections from the front and back surfaces of LiNbO₃. In step 44, a photoresist material is applied to the side containing the waveguides and BARC (or adhesion promoter) in step 44. The adhesion promoter promotes adhesion of the photoresist to the wafer. It should be noted that no adhesion promoter is required if BARC is used. Depending on the type of photoresist, BARC and the adhesion promoter step 42 may be eliminated. A suitable type of photoresist is the Ultra-I photoresist and a suitable type of BARC is available from the Shipley Company, LLC of Marlborough, Mass. The thickness of the photoresist layer should be minimal. When the sample is formed, 4000Å of photoresist was used. It should be understood that other photoresists that are capable of producing 0.18 μm features may be used. This resolution is required for making a distributed feedback reflector with period of 0.36μm, which is required for achieving a Bragg resonance in titanium-doped lithium niobate (Nₑ=2.145) at λ=1565 nm.

Referring now to FIGS. 4 and 5, the wafer having the photoresist thereon is exposed to ultraviolet radiation in step 46. As is best shown in FIG. 5, an interferometer 60 is preferably used. A laser source 62 such as a quadrupled Nd:YAG laser having a wavelength of 266 nm was used. The coherence length of the laser of over 10 cm at 30-60 mW of power at 15 Hz repetition rate approximately 15 mm diameter at the entrance of the interferometer was used. The laser source 62 generates a laser beam 64 that is divided by a 50/50 splitter 66 into two split beams 70 and 72. It should be noted that the two path lengths from beam splitter are set in equal length within a few millimeters of tolerance. This kept the path difference well below the coherence length of the ultraviolet laser source 62. Beam 72 is directed to a telescope 74 through a mirror 76. Beam 70 is also directed to a telescope 78. Each of the telescopes has a diverging lens 80 and a converging lens 82 having respective focal lengths of −40 mm and 200 mm. The distance d separating the lenses is 160 mm which is a summed combination of the focal lengths f₁ and f₂. Each of the shaped beams 84 and 86 are reflected to the wafer 90 using respective reflectors 92 and 94. A 46×3 mm aperture 96 is positioned along the side parallel to the plane of the figure in front of wafer 90 so that the most uniform area of beams is selected. The wafer is aligned so that the waveguides are oriented along the long edge of the beam (parallel to the plane of the figure). As evident from the figures, such configuration creates an oscillating optical field along the long axis of the laser spot. The angle of incidence α of the ultraviolet beam was determined from the formula

2\hat{ } sin α=λᵤᵥ (1)

where \hat{ } is the required period for the distributed feedback reflector from the Bragg resonance condition.

$$⋀ = \frac{{λ}_{IR}}{2 {n}_{o , e}} \qquad ( 2 )$$

where λ_{IR} is the IR resonant wavelength and n_{o,e} is the refraction index of LiNbO₃ at the extraordinary polarization of the IR beam. From (1) and (2), it is found that

$$sin α = {n}_{e} \frac{{λ}_{UV}}{{λ}_{IR}} . \qquad ( 3 )$$

This equation determines the incident angle of UV beam λ_{UV} that writes a uniform DFB structure that resonantly reflects back at the wavelength of λ. This results in sinα=0.365(α=21.4°) for nₑ≈2.145, λ_{UV}=266 nm and λ_{IR}=1565 nm.

In chirped grating, resonant conditions change linearly from λ_{IR}−Δλ_{IR}/2 at one end to λ_{IR}+Δλ_{IR}/2 at the other, which requires a linear change in the DFB period according to (2). Such a linear change in \hat{ } may be achieved by adjusting the incident angles of both interfering beams (e.g., by focusing one and defocusing the other) from α−Δα₂/2 at one end to α+Δα₂/2 at the other, where

$$Δ {α}_{2} = - tan α \frac{Δ {λ}_{IR}}{{λ}_{IR}} . \qquad ( 4 )$$

Alternatively, the incident angle of one of the interfering UV beams is kept constant, while the other is changed by an amount

$$Δ α = - 2 tan α \frac{Δ {λ}_{IR}}{{λ}_{IR}} . \qquad ( 5 )$$

For illustrative purposes, it is assumed that the right incident beam is focused, as shown in FIG. 5. The focal length F of the two-lens telescope comprised of a concave lens f₁ and convex f₂ is given by

$$\frac{1}{F} = \frac{1}{{f}_{1}} + \frac{1}{{f}_{2}} - \frac{d}{{f}_{1} {f}_{2}} , \qquad ( 6 )$$

where d=f₂+f₁+Δd is the distance between the two lenses and Δd is the de-tuning from the position that results in a collimated beam. Noting that F =D/Δα, where D is the size of UV beam at the output aperture of the telescope, it may be found from (6) that

$$Δ d = - \frac{{f}_{1} {f}_{2}}{D} Δ α . \qquad ( 7 )$$

Combining (7) and (5),

$$\vert Δ d \vert = \vert \frac{2 {f}_{1} {f}_{2} tan α}{D} \frac{Δ {λ}_{IR}}{{λ}_{IR}} \vert = 0.89 mm , \qquad ( 8 )$$

where it is assumed for illustrative purposes that Δλ_{IR}=10 nm and λ_{IR}=1565 nm.

Those skilled in the art will understand that other interferometer layouts that create interference patterns with required period may be used instead. Also, other UV wavelengths, preferably around 365 nm from an Ar-ion laser may also be employed.

In step 48, the exposed wafer is developed in the standard solution supplied by the manufacturer of the photoresist. If a BARC layer has been placed under photoresist, the wafer is first etched in a fluorocarbon plasma in step 49. The etching conditions depend on the plasma etching apparatus and must be determined independently for each machine, as explained by the BARC manufacturer (Shipley). In the present case, two minutes of etching in CF₄ plasma was used. In step 50, the developed wafer is milled by an argon ion beam for 10-16 minutes at 100 mA current until the photoresist is gone. The ion beam energy is set at 500 V. Those skilled in the art will understand that other ion energies and time/current combinations may be employed. For example, reducing the current by 50% requires doubling the milling time. It is preferable that the ion beam is incident on the water at 65-70 degrees. However, other incident angles e.g., normal to the surface, may also be used.

In step 52, the processed wafer is cleaned in an ultrasonic cleaner for 5-15 minutes in acetone oriented face down. After milling and cleaning, applying an isolating layer on the top of the wafer may be found in step 54. For example, 0.5-1 microns of silicon oxide. After that, in step 56 electrodes may be deposited (e.g., gold electrodes), using any technique employed in making EO phase and amplitude modulators.

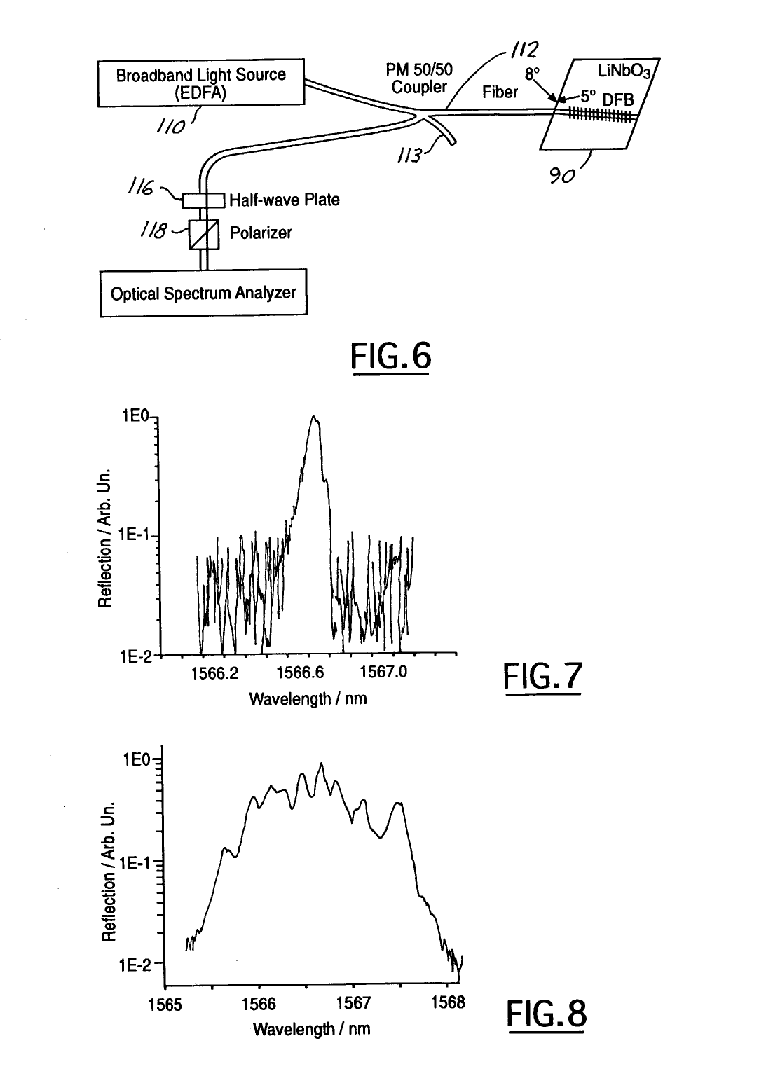

Referring now to FIGS. 4 and 6, in step 58 the distributed feedback reflectors manufactured in the waveguides are characterized by the apparatus shown in FIG. 6. Before the wafer is characterized, the edges are cut off using a diamond saw at an 85 degree angle with respect to the waveguides. That is, a cut normal to the surface makes a 5 degree angle with the waveguides. The cut leaves a polished surface of optical quality at the input and the output of the waveguides. The non-normal cut is chosen to suppress reflection from the fiber waveguide interference. As illustrated, a broadband optical light source couples light into a polarization maintaining 50/50 fiber coupler 112. The other end 113 of fiber is unused in this embodiment. The broadband optical source may operate at 1530 to 1570 nm. The coupler's output fiber is used for directing light into the waveguide containing the manufactured DFB reflector. The end of the fiber is cut at an angle of 8 degrees along one of the polarization maintaining coupler axes which are not shown. The non-normal cut is chosen to suppress reflection from the fiber waveguide interface. The 8 degrees and 5 degrees cut angles match refraction conditions from fused silica to the lithium niobate. Those skilled in the art will recognize that other fiber/lithium niobate cut angles may satisfy refractive conditions between the two media. In general, the fiber cut angle should be kept between 7 and 9 degrees above before avoiding back reflection. On the other hand, very large cut angles are very difficult to achieve and to use in operation. The light reflected by the reflector is reflected back into the polarization maintaining fiber coupler 112. The optical signal is split into an optical spectrum analyzer 114 by the coupler 112, it passes through a halfway plate 116 and a polarizer 118.

Referring now to FIG. 7, a measured reflection spectrum of a uniform (non-chirped) DFB is illustrated. The reflection at the peak is above 5 to 10 percent in both FIGS. 7 and 8. The reflected light is polarized nearly along the Z axis of the wafer, as is expected from the Bragg conditions.

Referring now to FIG. 8, chirped DFB reflector is illustrated. The chirped grating is not flat across the stop band, which is attributed to the residual non-uniformity of the UV beam. The spike wiggles in the stop band may be eliminated when a transform limited beam is used in the lithographic process.

While particular embodiments of the invention have been shown and described, numerous variations and alternate embodiments will occur to those skilled in the art. Accordingly, it is intended that the invention be limited only in terms of the appended claims.

What is claimed is:

1. A method for manufacturing a distributed feedback reflector comprising:
forming a waveguide on a wafer;
applying a photoresistive material to the wafer;
forming a grating on the photoresistive material;
developing the photoresistive material; and
milling the substrate to form the distributed feedback reflector.

2. A method as recited in claim 1 wherein before applying a photoresistive material to the substrate, applying an adhesion promoter or broadband anti-reflection coating to the substrate.

3. A method as recited in claim 1 wherein prior to developing, exposing the wafer to ultraviolet light.

4. A method as recited in claim 3 wherein exposing the wafer to ultraviolet light comprises exposing the wafer to ultraviolet light using an interferometer.

5. A method as recited in claim 4 wherein exposing the wafer to ultraviolet light comprises exposing the wafer to ultraviolet light using an interferometer having a Nd:YAG laser.

6. A method as recited in claim 4 wherein exposing the wafer to ultraviolet light comprises exposing the wafer to ultraviolet light using an interferometer having two beams having an angle of about 21 degrees therebetween.

7. A distributed feedback reflector formed according to the method as recited in claim 1.

8. An opto-electric delay generator having a distributed feedback reflector formed according to the method as recited in claim 1.

9. A method for manufacturing a distributed feedback reflector comprising:
forming a waveguide on a lithium niobate wafer;
applying an adhesion promoter to the wafer;
applying a photoresistive material to the wafer;
exposing the wafer to ultraviolet;
forming a grating on the photoresistive material;
developing the photoresistive material;
milling the substrate to form the distributed feedback reflector.

10. A method as recited in claim 9 further comprising the step of characterizing the wafer.

11. A method as recited in claim 10 wherein the step of characterizing the wafer comprises directing a broadband light source to the wafer to generate a reflected beam.

12. A method as recited in claim 9 further comprising depositing an insulating layer on the wafer.

13. A method as recited in claim 12 depositing an electrode on the insulating layer.

14. A method of forming an optical communication system comprising:
forming a waveguide on a lithium niobate wafer;
applying an adhesion promoter or broadband anti-reflection coating to the wafer;
applying a photoresistive material to the wafer;
exposing the wafer to ultraviolet;
forming a grating on the photoresistive material;
developing the photoresistive material;
milling the substrate to form the distributed feedback reflector; and
coupling the distributed feedback reflector into the optical communication network.

15. A method as recited in claim 14 before the step of coupling depositing an isolating layer on the layer and forming an electrode thereon.
